(19) United States
(12) Patent Application Publication
(10) Pub. No.: US 2026/0166588 A1
(43) Pub. Date: Jun. 18, 2026

(54) ULTRASONIC TRANSDUCER DEVICE

(71) Applicant: QISDA CORPORATION, Taoyuan City (TW)

(72) Inventors: Fu-Sheng Jiang, Taoyuan City (TW); Cheng-Chieh Juan, New Taipei City (TW)

(73) Assignee: QISDA CORPORATION, Taoyuan City (TW)

(21) Appl. No.: 19/299,378

(22) Filed: Aug. 14, 2025

(30) Foreign Application Priority Data
Dec. 12, 2024 (TW) 113148387

(51) Int. Cl. B06B 1/06

(52) U.S. Cl. CPC B06B 1/0685; B06B 1/067

(57) ABSTRACT

An ultrasonic transducer device that can improve a signal-to-noise ratio includes a vibration reduction layer, an acoustic lens, a transducer module and an interface structure. The transducer module is disposed between the vibration reduction layer and the acoustic lens. The interface structure is disposed on a side of the transducer module adjacent to the vibration reduction layer. The interface structure has a plurality of substructures in a regularly arranged manner. A size difference between any two substructures of the plurality of substructures is lower than a predefined value.

### BACKGROUND OF THE INVENTION

### 1. FIELD OF THE INVENTION

The present invention relates to an ultrasonic transducer device, and more particularly, to an ultrasonic transducer device of improving a signal-to-noise ratio.

### 2. DESCRIPTION OF THE PRIOR ART

A conventional ultrasonic transducer device includes a vibration reduction layer, an acoustic lens, a piezoelectric material layer and an acoustic impedance matching layer. The piezoelectric material layer is disposed on the side of the vibration reduction layer close to the acoustic lens. The acoustic impedance matching layer is disposed between the piezoelectric material layer and the acoustic lens. The conventional ultrasonic transducer device often uses the material with high impedance values to manufacture the vibration reduction layer for lower reflectivity, such as high-density powder mixed with epoxy resin, but the production process is extremely difficult. The vibration reduction layer is further manufactured by high-density metal powder, and has short circuit defect that is difficult to overcome. In addition, the side of the piezoelectric material layer of the conventional ultrasonic transducer device facing the vibration reduction layer is a planar structure, which causes the ultrasonic signal to be reflected in an orthogonal direction, and too much noise is accumulated in the energy, thereby affecting the detection effect of the conventional ultrasonic transducer device. Design of an ultrasonic transducer device of improving the signal-to-noise ratio is an important issued in the related medical equipment industry.

### SUMMARY OF THE INVENTION

The present invention provides an ultrasonic transducer device of improving a signal-to-noise ratio for solving above drawbacks.

According to the claimed invention, an ultrasonic transducer device of improving a signal-to-noise ratio includes a vibration reduction layer, an acoustic lens, a transducer module and an interface structure. The transducer module is disposed between the vibration reduction layer and the acoustic lens. The interface structure is disposed on a side of the transducer module adjacent to the vibration reduction layer. The interface structure has a plurality of substructures in a regularly arranged manner. A size difference between any two substructures of the plurality of substructures is lower than a predefined value.

The ultrasonic transducer device of the present application can dispose the plurality of substructures on the piezoelectric material layer or the substrate of the transducer module in the regularly arranged manner. The size of the substructure can be set between 12.5% and 3.3% of the preset wavelength, or can be the odd multiple of one half of the preset wavelength, so as to cause the scattering for effectively attenuating the noise energy and/or increasing probability of the destructive interference. The shape of the substructure can be designed as a trapezoidal structure of the first embodiment and the second embodiment, or any other shape such as a triangular structure; design of the present application can be preferably applicable to the silver glue bonding process, but can also be applied to other bonding processes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structural diagram of an ultrasonic transducer device according to a first embodiment of the present application.

FIG. 2 is an appearance diagram of an interface structure according to the embodiment of the present application.

FIGS. 3 and 4 are diagrams of the interface structure in different views according to the embodiment of the present application.

FIG. 5 is a structural diagram of the ultrasonic transducer device according to a second embodiment of the present application.

### DETAILED DESCRIPTION

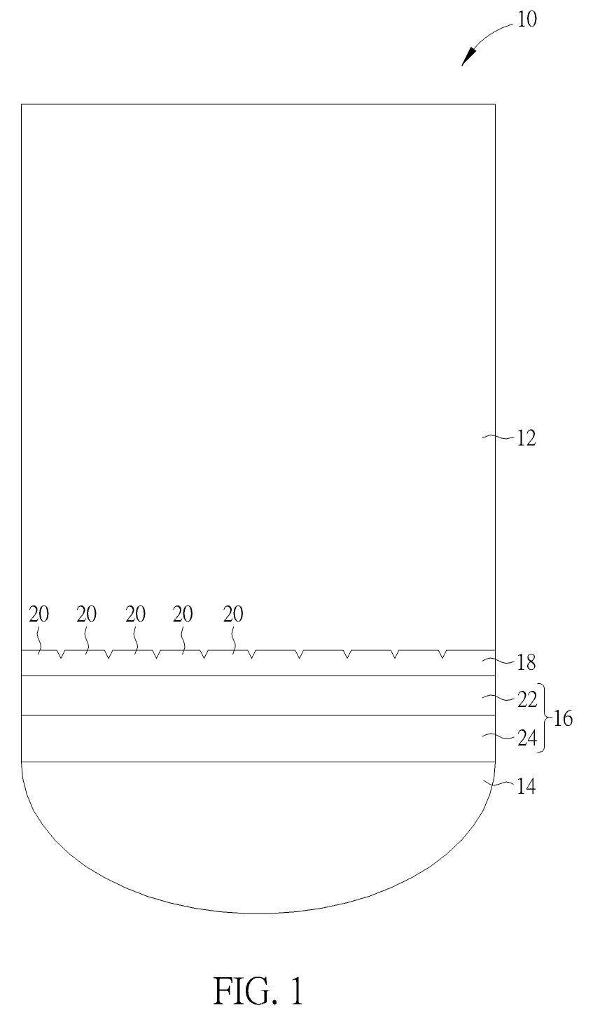

Please refer to FIG. 1. FIG. 1 is a structural diagram of an ultrasonic transducer device 10 according to a first embodiment of the present application. The ultrasonic transducer device 10 can include a vibration reduction layer 12, an acoustic lens 14, a transducer module 16 and an interface structure 18. The vibration reduction layer 12 can be made of adhesive material. The acoustic lens 14 can change a direction of the sound wave in front of the ultrasonic transducer device 10 so as to focus the sound wave on a specific object. The transducer module 16 can be disposed between the vibration reduction layer 12 and the acoustic lens 14. The interface structure 18 can be disposed on a side of the transducer module 16 adjacent to the vibration reduction layer 12. The interface structure 18 can include a plurality of substructures 20 in a regularly arranged manner. A size difference between any two of the plurality of substructures 20 can be smaller than a predefined value, and therefore the size difference between any two substructures 20 can be the same or similar to each other, so as to effectively extend a transmission path of the ultrasonic signal, which results in attenuation of noise energy, and further to increase a signal-to-noise ratio of the ultrasonic transducer device 10. The foresaid predefined value can be defined in accordance with the sizes of the interface structure 18 and the substructures 20, and a detailed description is omitted herein for simplicity.

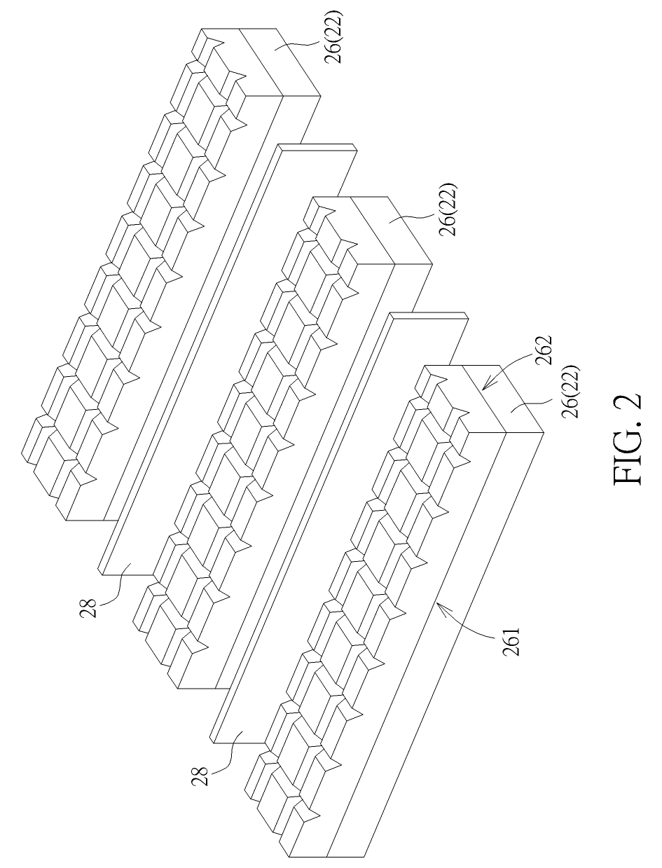

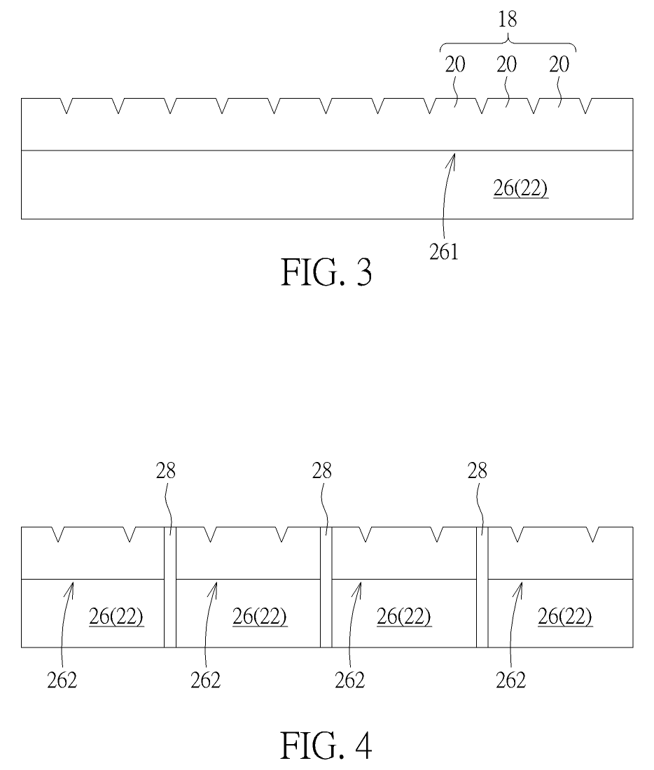

Please refer to FIGS. 2 to 4. FIG. 2 is an appearance diagram of the interface structure 18 according to the embodiment of the present application. FIGS. 3 and 4 are diagrams of the interface structure 18 in different views according to the embodiment of the present application. In the first embodiment, the transducer module 16 can include a piezoelectric material layer 22 and an acoustic impedance matching layer 24. The piezoelectric material layer 22 can be attached to the vibration reduction layer 12. The acoustic impedance matching layer 24 can be disposed between the piezoelectric material layer 22 and the acoustic lens 14. The interface structure 18 can be disposed on a side of the piezoelectric material layer 22 adjacent to the vibration reduction layer 12. As shown in FIG. 2, the piezoelectric material layer 22 can include a plurality of strip-shaped piezoelectric units 26. Each strip-shaped piezoelectric unit 26 can have a long side 261 and a short side 262 arranged adjacent to each other. The plurality of strip-shaped piezoelectric units 26 can be combined into the piezoelectric material layer 22 in a manner of being arranged in parallel on the short sides 262. An isolation layer 28 can be optionally disposed between the adjacent strip-shaped piezoelectric units 26, but an actual application is not limited thereto.

The interface structure 18 can be disposed on a side of the piezoelectric material layer 22 adjacent to the vibration reduction layer 12, such as a top side of the piezoelectric material layer 22 shown in FIG. 2. The plurality of substructures 20 of the interface structure 18 can be evenly distributed on the long side 261 of each strip-shaped piezoelectric unit 26, as shown in FIG. 3. A size of each substructure 20 can be preferably the same as or similar to an interval between the adjacent substructures 20, but the actual application is not limited thereto. The substructures 20 of the interface structure 18 can be disposed on the short side 262 of each strip-shaped piezoelectric unit 26, as shown in FIG. 4. However, due to the size difference between the short side 262 and the substructures 20, at least one substructure 20 being disposed on the short side 262 of each strip-shaped piezoelectric unit 26 can conform to a design scope of the present application.

The present application can compute a preset wavelength by analysis of the sound speed and the center frequency of the ultrasonic transducer device 10, and a size (or a structural width) of each substructure 20 can be preferably smaller than one quarter of the preset wavelength, so as to cause scattering and further to extend a transmission path (such as multiple reflections) of the ultrasonic signal for achieving a purpose of noise energy attenuation. For example, the center frequency and the sound speed of the ultrasonic signal emitted by the ultrasonic transducer device 10 can respectively be 10 MHz and 3000 m/s, and the preset wavelength can be computed as 0.3 mm, so that the size of the substructure 20 can be preferably smaller than 0.075 mm. The present application may further limit the size of the substructure 20 within a range between 12.5% and 3.3% of the preset wavelength, but an actual application is not limited thereto. It should be mentioned that each substructure 20 of the interface structure 18 of the ultrasonic transducer device 10 can be optionally set as an odd multiple of one half of the preset wavelength, which can allow the ultrasonic signal to form destructive interference inside the piezoelectric material layer 22, thereby increasing probability of the destructive interference.

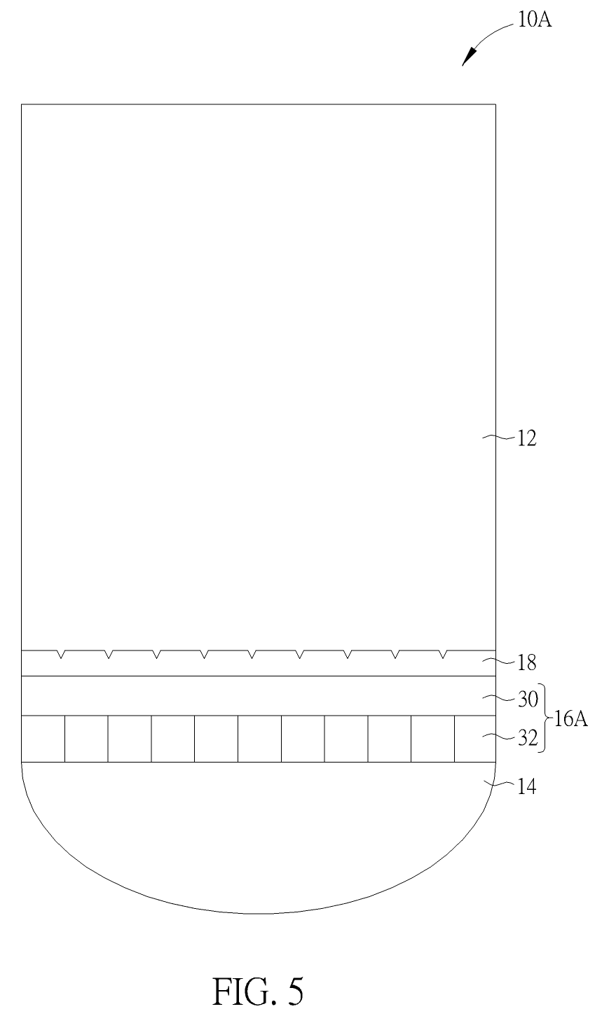

Please refer to FIG. 5. FIG. 5 is a structural diagram of the ultrasonic transducer device 10A according to a second embodiment of the present application. In the second embodiment, elements having the same numerals as ones of the first embodiment have the same structures and functions, and the detailed description is omitted herein for simplicity. The transducer module 16A of the ultrasonic transducer device 10A can include a substrate 30 and a plurality of vibration units 32. The substrate 30 can be a glass substrate attached to the vibration reduction layer 12. The plurality of vibration units 32 can be disposed between the substrate 30 and the acoustic lens 14. The interface structure 18 can be disposed on the side of the substrate 30 adjacent to the vibration reduction layer 12. The size of each substructure 20 of the interface structure 18 can be designed as the odd multiple of one half of the preset wavelength, or can be designed as being between 12.5% and 3.3% of the preset wavelength (which means being smaller than one quarter of the preset wavelength).

In conclusion, the ultrasonic transducer device of the present application can dispose the plurality of substructures on the piezoelectric material layer or the substrate of the transducer module in the regularly arranged manner. The size of the substructure can be set between 12.5% and 3.3% of the preset wavelength, or can be the odd multiple of one half of the preset wavelength, so as to cause the scattering for effectively attenuating the noise energy and/or increasing the probability of the destructive interference. A shape of the substructure can be designed as a trapezoidal structure of the first embodiment and the second embodiment, or any other shape such as a triangular structure (which is not shown in the figures); design of the present application can be preferably applicable to the silver glue bonding process, but can also be applied to other bonding processes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An ultrasonic transducer device of improving a signal-to-noise ratio, comprising:
a vibration reduction layer;
an acoustic lens;
a transducer module disposed between the vibration reduction layer and the acoustic lens; and
an interface structure disposed on a side of the transducer module adjacent to the vibration reduction layer, the interface structure comprising a plurality of substructures set in a regularly arranged manner, and a size difference between any two substructures of the plurality of substructures being smaller than a predefined value.

2. The ultrasonic transducer device of claim 1, wherein the transducer module comprises a piezoelectric material layer and an acoustic impedance matching layer, the piezoelectric material layer is attached to the vibration reduction layer, the acoustic impedance matching layer is disposed between the piezoelectric material layer and the acoustic lens, the interface structure is disposed on a side of the piezoelectric material layer adjacent to the vibration reduction layer.

3. The ultrasonic transducer device of claim 1, wherein the transducer module comprises a substrate and a plurality of vibration units, the substrate is attached to the vibration reduction layer, the plurality of vibration units is disposed between the substrate and the acoustic lens, the interface structure is disposed on a side of the substrate adjacent to the vibration reduction layer.

4. The ultrasonic transducer device of claim 1, wherein the ultrasonic transducer device computes a preset wavelength by analysis of a center frequency and a sound speed, and a size of each of the plurality of substructures is smaller than one quarter of the preset wavelength.

5. The ultrasonic transducer device of claim 4, wherein the size of the foresaid substructure is between 12.5% and 3.3% of the preset wavelength.

6. The ultrasonic transducer device of claim 1, wherein the ultrasonic transducer device computes a preset wavelength by analysis of a center frequency and a sound speed, and a size of each of the plurality of substructures is an odd multiple of one half of the preset wavelength.

7. The ultrasonic transducer device of claim 1, wherein a piezoelectric material layer of the transducer module comprises a plurality of strip-shaped piezoelectric units, each of the plurality of strip-shaped piezoelectric units has a long side and a short side arranged adjacent to each other, and the plurality of strip-shaped piezoelectric units is combined into the piezoelectric material layer in a manner of being arranged in parallel on the short side.

8. The ultrasonic transducer device of claim 7, wherein the plurality of substructures is evenly distributed on the long sides of the plurality of strip-shaped piezoelectric units.

9. The ultrasonic transducer device of claim 7, wherein at least one substructure is accordingly disposed on the short sides of the plurality of strip-shaped piezoelectric units.

10. The ultrasonic transducer device of claim 1, wherein each of the plurality of substructures is a trapezoidal structure or a triangular structure.
